(19) United States
(12) Patent Application Publication
(10) Pub. No.: US 2024/0328828 A1
(43) Pub. Date: Oct. 3, 2024

(54) HIGH-RESOLUTION INDUCTIVE SENSOR

(71) Applicant: COMMISSARIAT A L’ENERGIE ATOMIQUE ET AUX ENERGIES ALTERNATIVES, PARIS (FR)

(72) Inventors: Jean-Pierre NIKOLOVSKI, Saint-Paul-lez-Durance (FR); Driss ABOULKASSIMI, Saint-Paul-lez-Durance (FR)

(21) Appl. No.: 18/618,574

(22) Filed: Mar. 27, 2024

(30) Foreign Application Priority Data
Mar. 31, 2023 (FR) 2303184

(51) Int. Cl. G01D 5/20; G01G 7/02; G01L 1/14

(52) U.S. Cl. CPC G01D 5/2046; G01G 7/02; G01L 1/14

(57) ABSTRACT

An inductive sensor includes a fixed part and a movable part. The movable part comprising a movable or deformable proof body, and a magnetic coupling element mechanically secured to the proof body. The fixed part comprising: a voltage generator and a coil transformer comprising an emission inductance mounted in parallel with the generator and a reception inductance. The magnetic coupling element being separated from an end of the emission inductance by a separation distance. The fixed part comprises an acquisition chain connected to the reception inductance and configured to generate a distance variation measurement signal. The measurement signal corresponding to a measurement of the variation of the frequency or of the amplitude of the voltage at the terminals of the reception inductance.

### CROSS-REFERENCE TO RELATED APPLICATION

This application claims priority to foreign French patent application No. FR 2303184, filed on Mar. 31, 2023, the disclosure of which is incorporated by reference in its entirety.

### FIELD OF THE INVENTION

The invention relates to the field of detection of proximity and of movement or of deformation for producing sensors. More particularly, the invention relates to a sensor of movement of a movable or deformable proof body coupled to an inductive flux. The scope of the invention can cover weighing devices with wide dynamic range applied for laboratories (1 mg to 200 g), people (1 g to 200 kg) or major works (1 kg to 200 tonnes).

In the field of measurement devices, sensitivity is a crucial parameter, notably in weighing devices or pressure sensors. The sensitivity of a measurement device represents its capacity to detect small variations in the measurement. The more sensitive the device is, the more able it is to accurately measure variations in the measured quantity. More particularly, in the case of weighing devices, an increased sensitivity makes it possible to measure smaller quantities and obtain more accurate results. That can be particularly important in fields such as pharmacology, laboratory research or the agri-food industry, in which accurate and reliable measurements are essential to ensure the quality and the safety of the products or of the scientific research results. Consequently, an adequate sensitivity is essential to guarantee the precision of the results and meet the quality standards currently in force.

In addition, the dynamic range is another important parameter in measurement devices generally, and in weighing or pressure measurement devices in particular. «Dynamic range» is understood to mean the interval comprising the values that are measurable by the measurement device, ranging from the smallest detectable measurement to the largest. A high dynamic range means that the device can measure very small quantities as well as very high quantities. More particularly, in the case of the weighing devices, a wider dynamic range can be particularly useful in the situations in which objects of different weights have to be weighed. For example, a balance with a wider dynamic range can be used to weigh small samples in a research laboratory, and to weigh greater quantities of raw materials in industry. By having a wider dynamic range, the users can obtain accurate and reliable results for a wide panoply of measurements, which is essential for many applications.

In this context, the analysis of the deformation of a proof body presents a solution that is suitable for measuring an applied weight or a force. This method uses an elastic proof body, which is a structural element designed to undergo a deformation in response to an applied force. The deformation provokes a variation of physical characteristics of the proof body which can be converted into electrical signals. For example, the relative deformation of a proof body comprising piezoresistive deformation gauges generates a relative variation of the resistance of the strain gauges. The measurement of this variation of the resistance, necessitates sticking the gauges onto the proof body and establishing a physical electrical connection between the proof body and an electronic circuit. The sensitivity to mechanical shocks and the connection system considerably reduce the robustness of the sensor because a part of the measurement electronics undergoes the mechanical forces applied during the measurement. In engineering, the robustness of a system is defined as the stability of the performance levels despite external conditions exhibiting wide variations that are likely to reduce the reliability of the system. In addition, the total or partial implementation of the measurement electronics on the proof body limits the dynamic range of the sensor to avoid damaging the measurement electronics.

Thus, the objective is to develop a measurement sensor on the basis of a deformable and/or movable proof body with a high sensitivity, a wide dynamic range while ensuring its mechanical and electronic robustness so making it possible to enhance the reliability and the lifetime of the sensor.

### BACKGROUND

The international patent application WO98/19133 describes a dimensional checking device based on the local and selective generation and detection of ultrasounds. The solution is based on the coupling of the ultrasound field between the read head and the surface of the object being probed. The drawback of the solution described is that the measurement device exhibits a high temperature dependency of the order of 1700 ppm/° C. which necessitates a compensation of the drift in temperature of the measurement signal by means of a high-resolution temperature sensor.

The patent application DE10048435A1 describes an inductive sensor of lateral movement of a movable object with respect to a fixed object. The device detects the variations in translation by maintaining a fixed distance between a conductive surface and a circuit in coil form. Although it is effective for detecting the passage of objects, this configuration does not offer a great dynamic range in the direction at right angles to the plane of the detector, or a high resolution at right angles to the plane of the coil.

### Response to the Issue and Solution Provided

To mitigate the limitations of the existing solutions with respect to sensitivity, dynamic range and robustness, the invention proposes a sensor which exploits the variation of the relative magnetic permeability of an inductive impedance coupled directly or indirectly with a magnetic coupling element secured with a proof body. The invention is based on a variation of a frequency response of said inductive impedance in response to a pulsed stimulation and/or the variation of a measured amplitude in response to a voltage ramp signal. The invention allows a contactless measurement between the electronic signal processing circuit and the proof body which undergoes mechanical stresses. In addition, the device according to the invention exhibits a low dependency on temperature, which enhances its stability compared to the solutions of the prior art.

### SUMMARY OF THE INVENTION

The subject of the invention is an inductive sensor comprising a fixed part and a movable part; the movable part comprising:
a proof body that is movable or deformable, in a first direction, and a magnetic coupling element mechanically secured to the proof body;
the fixed part comprising:
a voltage generator configured to generate an excitation signal; a coil transformer comprising an emission inductance mounted in parallel with the generator and a reception inductance; the axis of the emission inductance and the axis of the reception inductance being oriented in the first direction; the magnetic coupling element being placed with respect to the coil transformer so as to magnetically couple the emission inductance and the reception inductance; the magnetic coupling element being separated from an end of the emission inductance by a separation distance;
an acquisition chain connected to the reception inductance and configured to generate a distance variation measurement signal following a movement or the deformation of the proof body; the measurement signal corresponding to a measurement of the variation of the frequency or of the amplitude of the voltage at the terminals of the reception inductance.

According to a particular aspect of the invention, the acquisition chain comprises an analogue-digital converter for converting the voltage at the terminals of the reception inductance into a first digital signal.

According to a particular aspect of the invention, the acquisition chain comprises a computer configured to:
extract the resonance frequency of the voltage at the terminals of the reception inductance from the first digital signal. Calculate the deviation between the extracted resonance frequency and a predetermined reference frequency.

According to a particular aspect of the invention, the excitation signal is a square-wave pulse.

According to a particular aspect of the invention, the fixed part further comprises a capacitive element and a resistive element mounted in series with the emission inductance so as to produce an RLC circuit powered by the voltage generator.

According to a particular aspect of the invention, the acquisition chain comprises a computer configured to:
perform a sampling of the first digital signal in order to extract the amplitude of the voltage at the terminals of the reception inductance;
calculate the deviation between the extracted amplitude and a predetermined reference amplitude.

According to a particular aspect of the invention, the excitation signal is a voltage ramp.

According to a particular aspect of the invention, the acquisition chain comprises an amplifier circuit mounted upstream of the analogue-digital converter to amplify the voltage at the terminals of the reception inductance.

According to a particular aspect of the invention, the magnetic coupling element is an object made of a ferrite material in π form or in half-torus form or in rod form or in sheet form.

According to a particular aspect of the invention, the ferrite material is chosen such that the thermal sensitivity of the relative magnetic permeability of said material is less than 1%/° C.

According to a particular aspect of the invention, the emission inductance and the reception inductance are produced in coplanar metal tracks deposited on a printed circuit.

According to a particular aspect of the invention, each of the emission inductance and of the reception inductance is produced by a coil wound around a solid rod.

According to a particular aspect of the invention, the emission inductance is disposed alongside the reception inductance, or superposed on the reception inductance.

According to a particular aspect of the invention, the movable part comprises N magnetic coupling elements mechanically secured to the proof body that are aligned in a row, with N an integer strictly greater than 1; and in which the fixed part comprises N−1 intermediate magnetic coupling elements disposed between the emission inductance and the reception inductance.

Also a subject of the invention is a weight or pressure measurement device comprising an inductive sensor according to the invention.

### BRIEF DESCRIPTION OF THE DRAWINGS

Other features and advantages of the present invention will become more apparent on reading the following description in relation to the following attached drawings.

FIG. 1a illustrates the electrical diagram of the inductive sensor according to a first embodiment of the invention.

FIG. 1b illustrates a spectral analysis of the voltage at the terminals of the reception inductance of the inductive sensor according to the first embodiment of the invention.

FIG. 1c illustrates the electrical diagram of the inductive sensor according to a second embodiment of the invention.

FIG. 2a illustrates the electrical diagram of the inductive sensor according to a third embodiment of the invention.

FIG. 2b illustrates an example of the trend over time of the electrical signals from the inductive sensor according to the third embodiment of the invention.

FIG. 3 illustrates a cross-sectional view of a first embodiment of the inductive part of the sensor according to the invention.

FIG. 4 illustrates a cross-sectional view of a second embodiment of the inductive part of the sensor according to the invention.

FIG. 5a illustrates a cross-sectional view of a third embodiment of the inductive part of the sensor according to the invention.

FIG. 5b illustrates a partial top view of the third embodiment of the inductive part of the sensor according to the invention.

FIG. 6 illustrates a cross-sectional view of a fourth embodiment of the inductive part of the sensor according to the invention.

FIG. 7 illustrates a cross-sectional view of a fifth embodiment of the inductive part of the sensor according to the invention.

### DETAILED DESCRIPTION

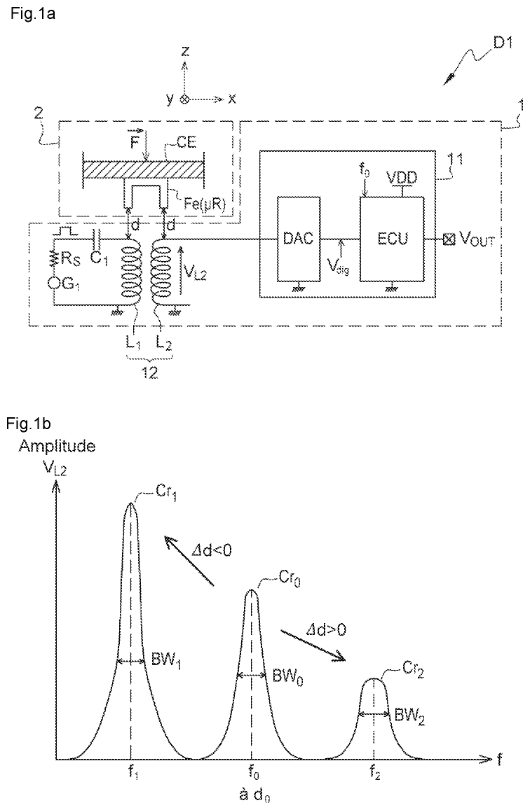

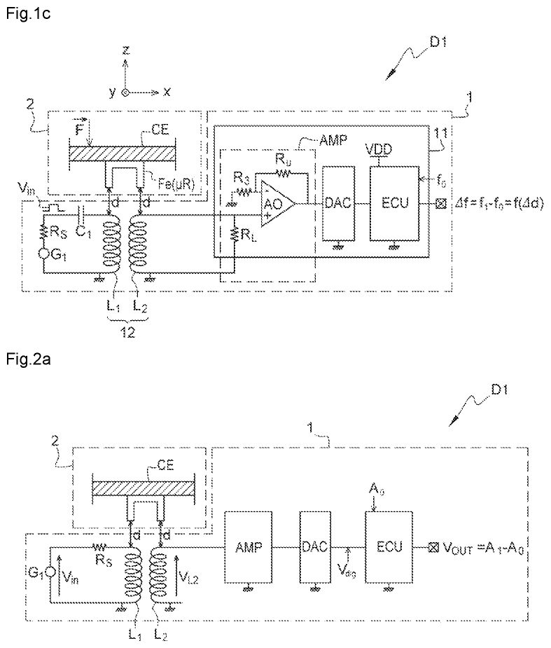

FIG. 1a illustrates the electrical diagram of the inductive sensor D1 according to a first embodiment of the invention. The inductive sensor D1 comprises a fixed part 1 and a part 2 that is movable in a first direction Z in an orthonormal reference frame (X, Y, Z).

The movable part 2 comprises a proof body CE and a magnetic coupling element Fe mechanically secured to the proof body CE.

The proof body CE is a bridge or a plate orthogonal to the first direction Z. The proof body CE can be movable or elastically deformable in the first direction Z following the application of a force F in said first direction. The applied force F corresponds for example to the weight of a physical object resting on the proof body CE or to a pressure exerted on its top surface. In the case of a proof body CE that is movable by translation in the first direction Z, elastic means are attached to the proof body CE in order to replace it in its initial position in the absence of an applied force F.

The magnetic coupling element Fe is mechanically secured to the proof body CE so as to follow its movement or its deformation in the first direction Z. The magnetic coupling element Fe is an object produced in ferromagnetic material in π form or in half-torus form or in rod form or in sheet form. As an example, the ferromagnetic material is a ferrite produced in an alloy of Ni—Zn or Mn—Zn or Co—Ni—Zn.

Advantageously, the ferromagnetic material exhibits a thermal sensitivity of said relative magnetic permeability μr less than 1%/° C. Furthermore, the ferromagnetic material has a high bandwidth ranging up to 50 MHz.

Advantageously, apart from the sheet case, it is possible to wind metal turns around the magnetic coupling element Fe in order to improve the magnetic coupling capabilities of the magnetic coupling element Fe.

In the example illustrated, the magnetic coupling element Fe is in π form, comprises a base and two parallel protuberances which extend from said base in the first direction Z. The protuberances can be straight rods, or be of tapered form. The base is fixed onto a surface, preferably the bottom surface, of the proof body CE, and the protuberances extend orthogonally to said surface downwards.

The fixed part 1 comprises a voltage generator G1, a coil transformer 12 comprising an emission inductance L₁ mounted in parallel with the generator G1 and a reception inductance L₂, and an acquisition chain 11 connected to the reception inductance L₂.

The generator G1 is configured to generate an excitation signal Vᵢₙ in electrical pulse form and exhibits an output resistance Rs less than 0.5Ω. The fixed part 1 further comprises a capacitive element C1 mounted in series with the output resistance Rs and the emission inductance L₁. The capacitive element C₁, the output resistance Rs and the emission inductance L₁ together form an RLC circuit excited by the electrical pulse Vᵢₙ generated by the generator G1. The dimensioning of the capacitive element C1 and the emission inductance L₁ is chosen so as to have a damping factor ζ less than 0.7 so as to obtain a damped oscillatory regime following the application of the electrical pulse Vᵢₙ.

The reception inductance L₂ is placed in proximity to the emission inductance L₁ to allow a magnetic coupling between the two inductances and thus obtain an energy transformer 12 mode of operation. The axis of the emission inductance L₁ and the axis of the reception inductance L₂ are oriented in the first direction Z. Thus, the variations of the voltage at the terminals of the emission inductance L₁ are reproduced at the terminals of the reception inductance L₂. The initial state of the inductive sensor D1 corresponds to the absence of a force F on Z applied to the proof body CE. In the initial state of the sensor D1, the first protuberance of the magnetic coupling element Fe in π form is placed at a predetermined initial distance d=d₀ with respect to the top end of the emission inductance L₁.

Advantageously, in the initial state of the sensor D1, the second protuberance of the magnetic coupling element Fe in π form is placed at said predetermined distance d=d₀ with respect to the top end of the reception inductance L₂. This configuration offers the advantage of twice duplicating the dependency of the magnetic flux produced at the axial output of the emission inductance L₁ with the variation of the distance d: a first dependency characteristic of the axial decay of the magnetic flux produced by the emission inductance L₁ when the magnetic coupling element is moved away or brought closer and a second dependency which characterizes the transfer of the magnetic field from the magnetic coupling element to the reception inductance L₂.

The emission inductance L₁, the reception inductance L₂ and the magnetic coupling element Fe together form an assembly called «inductive part» of the sensor D1. The «inductive part» has an equivalent inductance value L_{eq}.

The response to an excitation by a square-wave pulse Vᵢₙ of the circuit RₛL_{eq}C₁ is a damped pseudo-periodic oscillation. The oscillatory response is also reproduced at the terminals of the reception inductance L₂ by magnetic coupling. The resonance frequency f observed at the terminals of the reception inductance L₂ is determined by the following expression:

$$f = \frac{1}{2 π \sqrt{{L}_{e q} {C}_{1}}} ≅ \frac{1}{2 π \sqrt{\frac{4 π {μ}_{r , eq} {μ}_{0} {N}^{2} {R}^{2} {C}_{1}}{l + 0.9 R}}}$$

With N the number of contiguous turns of the emission inductance L₁, R the radius of the turns of the emission inductance L₁, I the length of the contiguous turns of the emission inductance L₁, μ₀ the magnetic permeability of the vacuum and μ_{r,eq} the equivalent relative magnetic permeability of the inductive part as a function of the relative magnetic permeability μr of the magnetic coupling element and the distance d separating the magnetic coupling element Fe from the emission inductance L₁.

Among the abovementioned parameters, the distance d is the only parameter that is variable following the application of a force F on the proof body CE. The application of the force F in the direction Z induces the translation or the deformation of the proof body CE in the direction Z. That induces a variation of the distance d separating the magnetic coupling element Fe from the emission inductance L₁. That induces a variation of μ_{r,eq}, the equivalent relative magnetic permeability of the inductive part. That induces a variation of the resonance frequency of the voltage V_{L2} observed at the terminals of the reception inductance L₂ in response to the square-wave electrical pulse Vᵢₙ. This chain of dependency thus makes it possible to convert the amplitude of the applied force F into a measurable parameter, namely the variation of the resonance frequency f.

The acquisition chain 11 comprises an analogue-digital converter DAC for converting the voltage V_{L2} (analogue signal) at the terminals of the reception inductance L₂ into a first digital signal V_{dig}. The first digital signal V_{dig} thus corresponds to a digitized oscillatory signal with a resonance frequency f equal to that of the voltage V_{L2}. The analogue-digital converter DAC is characterized by a predetermined sampling frequency f_{DAC}. The values of the capacitance C₁ and of the emission inductance L₁ are chosen so as to always have a resonance frequency F less than half the sampling frequency f_{DAC} of the analogue-digital converter DAC. For example, the sampling frequency f_{DAC} is equal to 12 MHz so the resonance frequency f is always less than 6 MHz when the sensor D1 is operating.

The acquisition chain 11 further comprises a computer ECU configured to:
carry out a Fourier analysis of the first digital signal V_{dig} in order to extract the resonance frequency f₁ of the voltage V_{L2} at the terminals of the reception inductance L₂ in response to the square-wave pulse Vᵢₙ with a force F that is non-zero and d=d₁≠d₀,
calculate the deviation Δf between the extracted resonance frequency f₁ and a predetermined reference frequency f₀.

The reference frequency f₀ is measured beforehand in a calibration step corresponding to the following conditions: F=F₀ and d=d₀. The reference frequency f₀ is then stored as digital datum in the memory of the computer ECU. In the calibration operation, it is possible to be based on a reference applied force F=F₀ that is non-zero.

The sensor thus generates a signal Vₒᵤₜ of measurement of the variation of the distance Δd following a movement or the deformation of the proof body CE. The measurement signal Vₒᵤₜ corresponding to a measurement of the variation of the frequency Δf=f₁−f₀.

Advantageously, the ferromagnetic material of the magnetic coupling element Fe exhibits an initial relative magnetic permeability μr between 1 and 1500. That makes it possible to increase the effect of the variation of the distance separating the magnetic coupling element Fe on the variation of the equivalent inductance L_{eq} with a range of variation of between 10% to 400% and more particularly around 50% to 150%.

Advantageously, the protuberances of the magnetic coupling element Fe have a diameter less than that of the inductances L₁ and L₂. Their profile can be tapered. Thus, the insertion of the protuberances of the magnetic coupling element Fe in each of the inductances L₁ and L₂ makes it possible to considerably increase the dynamic range of the sensor D1. In addition, that makes it possible to maximize the magnetic coupling between the inductances L₁ and L₂ and thus increase the sensitivity of the inductive sensor according to the invention.

In the solution according to the invention, the physical quantity that is variable following the application of a force is a separation distance. The fixed part 1 corresponds to the measurement electronic circuitry which is not implemented directly on the proof body CE. That makes it possible to avoid applying mechanical stresses on the measurement electronic circuitry when using the sensor D1. That makes it possible to avoid the degradation of the components and electrical connections and thus makes it possible to improve the robustness of the sensor D1 with respect to the prior art solutions.

FIG. 1b illustrates a spectral analysis of the voltage V_{L2} at the terminals of the reception inductance L₂ of the inductive sensor D1 according to the first embodiment of the invention. The curve Cr0 corresponds to the initial state (d=d₀); the curve Cr1 corresponds to the magnetic coupling element Fe moving toward the excitation inductance L₁ (d=d₁<d₀); the curve Cr2 corresponds to the magnetic coupling element Fe moving away from the magnetic coupling element L₁ (d=d₂>d₀).

When the magnetic coupling element Fe approaches the ends of the inductances L₁ and L₂, the distance d decreases. That induces an increase of the equivalent relative magnetic permeability μ_{r,eq} of the inductive part which is reflected by an increase of the equivalent inductance L_{eq} and at the same time a stronger magnetic coupling between the emission inductance L₁ and the reception inductance L₂. This effect is amplified if the magnetic losses in the magnetic coupling element Fe are low, which is the case of a ferrite in Π or half-torus form. Advantageously, the number of turns of the reception inductance L₂ is greater, by preferably 2 to 5 times, than the number of turns of the emission inductance L₁ so as to improve the sensitivity of the inductive sensor according to the invention.

Three results are then obtained simultaneously: a reduction of the measured resonance frequency Δf=f₁−f₀>0; an increase of the amplitude of the resonance peak because the magnetic coupling is improved; and an increase of the quality factor Q of the inductive part because the width of the resonance peak is reduced (BW1−BW0<0). Conversely, when the magnetic coupling element Fe moves away from the ends of the inductances L₁ and L₂, the distance d increases. That induces a reduction of the equivalent relative magnetic permeability μ_{r,eq} of the inductive part; which reduces the value of the equivalent inductance L_{eq} and at the same time is reflected by a weaker magnetic coupling between the emission inductance L₁ and the reception inductance L₂. Three results are then obtained simultaneously: an increase of the measured resonance frequency Δf=f₂−f₀>0; a reduction of the amplitude of the resonance peak because the magnetic coupling is reduced; and a reduction of the quality factor Q of the inductive part because the width of the resonance peak is increased (BW2−BW0<0).

Thus, an inductive sensor D1 is obtained that has performance levels that are enhanced in terms of sensitivity, of dynamic range and of robustness. For example, the resonance frequency can vary by 50%, with a range of between, preferably, 2 and 6 MHz with a maximum travel of 3 mm in the first direction Z, preferably less than 1 mm. The frequency resolution is approximately 2.5 ppm (parts per million) with a measurement rate of 5 Hz, whereas the resolution in variation of the distance d is approximately 10 nm.

FIG. 1c illustrates the electrical diagram of the inductive sensor D1 according to a second embodiment of the invention. The structural and functional features described for the first embodiment remain valid for the second embodiment. In the mode illustrated, the fixed part 1 further comprises an amplifier circuit AMP mounted upstream of the analogue-digital converter DAC to amplify the voltage V_{L2} at the terminals of the reception inductance L₂. That makes it possible to improve the sensitivity of the inductive sensor D1. As a nonlimiting example, the amplifier circuit is produced by a wideband operational amplifier AO configured in a non-inverting arrangement with an amplification gain equal to

$$1 + \frac{R 4}{R 3}$$

of between 2 and 11. The amplification circuit AMP has an input impedance R_{L} greater than or equal to 10⁵ times the residual resistance of the turns of the reception inductance L₂.

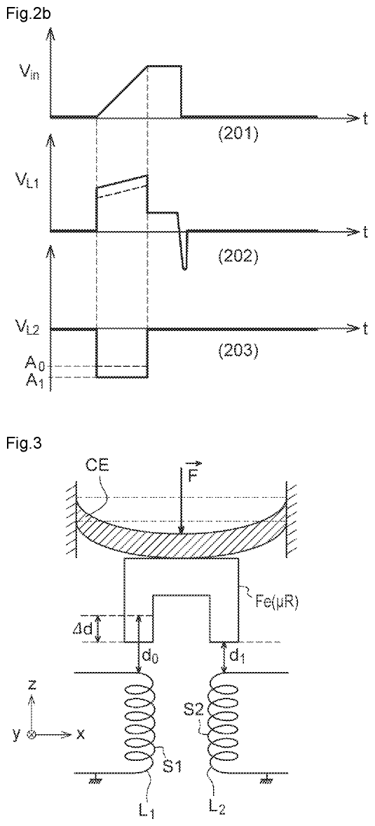

FIG. 2a illustrates the electrical diagram of the inductive sensor D1 according to a third embodiment of the invention. In this embodiment, the quantifying of the variation of the distance d is done by a measurement of amplitude and not of frequency. The generator G1 is configured to generate an excitation signal Vᵢₙ in voltage ramp form. The voltage ramp Vᵢₙ creates a transient magnetic flux by the emission inductance L₁ with a temporal current variation di/dt that is constant. FIG. 2b illustrates an example of the trend over time of the electrical signals from the inductive sensor D1 according to the third embodiment of the invention. The voltage ramp of the excitation signal Vᵢₙ is reproduced at the terminals of the emission inductance L₁ because of the residual resistance of said emission inductance. A voltage ramp V_{L1} obtained for a distance d₁ less than the initial distance do is illustrated in the diagram (202) by a continuous line. A voltage ramp V_{L1} obtained for the distance do corresponding to a zero force F is illustrated in the diagram (202) by a dotted line. In the diagram (203), a voltage plateau V_{L2} is obtained at the terminals of the reception inductance L₂ having an amplitude A₁ presented by a continuous line. The amplitude A₁ associated with a distance d₁<d₀ is greater than the amplitude A0 corresponding to the initial distance d₀. The voltage plateau V_{L2} is obtained by virtue of the high input impedance of the acquisition chain 11 connected to the reception inductance L₂. In the third embodiment, the computer ECU is configured to:
carry out a sampling of the first digital signal V_{dig} in order to extract the amplitude A₁ of the voltage V_{L2} at the terminals of the reception inductance L₂;
and to calculate the deviation between the extracted amplitude A₁ and a predetermined reference amplitude A₀.

The reference amplitude A₀ is measured beforehand in a calibration step corresponding to the following conditions: F=F0 (with F0 possibly zero) and d=d₀. The reference amplitude A₀ is then stored as digital datum in the memory of the computer ECU.

The sensor thus generates a signal Vₒᵤₜ of measurement of the variation of the distance Δd following a movement or the deformation of the proof body CE. The measurement signal Vₒᵤₜ corresponds to a measurement of the variation of the amplitude ΔA=A₁−A₀.

The voltage plateau V_{L2} makes it possible to obtain a plurality of amplitude measurement points. The computer is thus configured to carry out an acquisition of several measurement points and then calculate an average to improve the resolution of the measurement.

FIG. 3 illustrates a cross-sectional view of a first embodiment of the inductive part of the sensor D1 according to the invention. It is recalled that the inductive part of the sensor is composed of the emission inductance L₁, the reception inductance L₂ and the magnetic coupling element Fe. In this first example, the emission inductance L₁ and the reception inductance L₂ are placed alongside one another and are laterally weakly coupled magnetically by having, if necessary, recourse to an external magnetic shielding such as a ferrite cylinder. Each inductance L₁ and L₂ is produced by a winding of a conductive wire around a distinct hollow support (S1 and S2) filled with air, typically a non-magnetic insulating hollow cylinder, made of polymer for example. The turns are contiguous, having a diameter of between 40 μm and 100 μm. The length I of the aggregated contiguous turns of each conductive wire is less than 3 mm to obtain a residual resistance of the winding less than 1Ω. That makes it possible to improve the quality factor of the inductive part and thus improve the sensitivity of the inductive sensor D1.

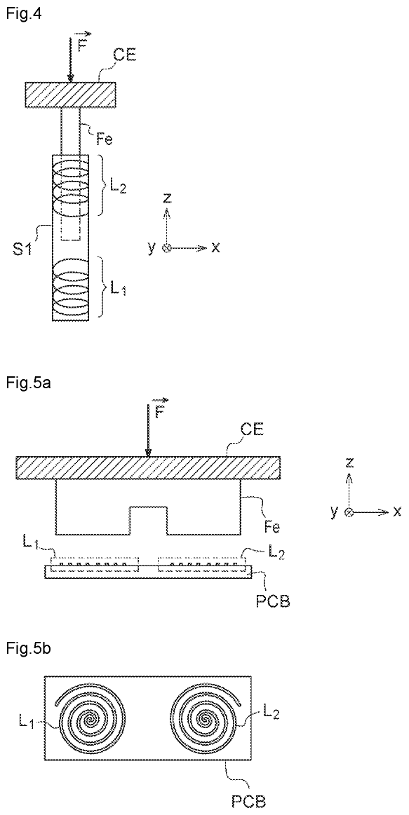

FIG. 4 illustrates a cross-sectional view of a second embodiment of the inductive part of the sensor D1 according to the invention. In this embodiment, the emission inductance L₁ is superposed on the reception inductance L₂ on the same axis. This is then a direct magnetic coupling. Thus, the direct magnetic coupling between the two inductances is improved and the reception inductance L₂ contributes strongly to the definition of the resonance of the inductive part of the sensor according to the invention. The magnetic coupling element Fe is a rod made of the ferromagnetic material described previously. Each inductance L₁ and L₂ is produced by a winding of an enameled conductive wire around a common hollow support S1 filled with air, typically a non-magnetic insulating hollow cylinder, made of polymer for example. The rod Fe is inserted into the hollow support S1. Advantageously, the rod Fe is inserted on the side of the reception inductance L₂. That makes it possible to first of all primarily increase the reception inductance L₂ without increasing the emission inductance L₁, and thus make it possible to create a voltage step-up transformer while beginning to lower the resonance frequency by mutual inductance. Then, when the rod reaches the core of L₁, the mutual inductance is the strongest and the frequency is minimal. The rod Fe is mechanically secured to the proof body CE. The translation of the rod Fe in the hollow support S1 therefore modifies the magnetic coupling between the emission inductance L₁ and the reception inductance L₂. That induces a modification of the frequency and of the amplitude of the output signal Vₒᵤₜ as described previously.

FIG. 5a illustrates a cross-sectional view of a third embodiment of the inductive part of the sensor D1 according to the invention. FIG. 5b illustrates a partial top you of the third embodiment of the inductive part of the sensor D1 according to the invention. The emission inductance L₁ and the reception inductance L₂ are coplanar. The two inductances are disposed flat with a snail-form winding alongside one another on the same face of a printed circuit board PCB. The windings are produced by metal turns deposited on the printed circuit board PCB.

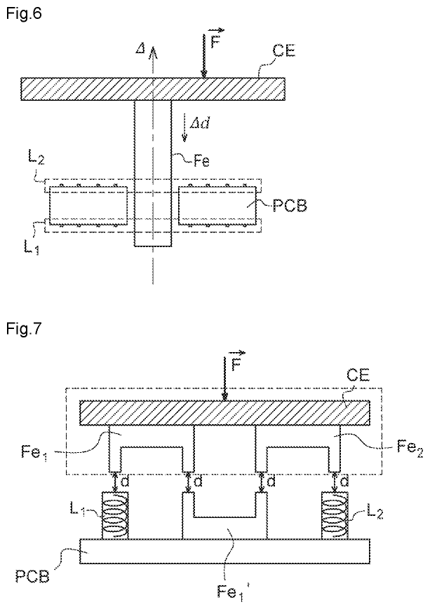

FIG. 6 illustrates a cross-sectional view of a third embodiment of the inductive part of the sensor D1 according to the invention. The emission inductance L₁ is produced by a winding of a metal track on the top face of a printed circuit board PCB. The reception inductance L₂ is produced by a winding of a metal track on the bottom face of the printed circuit board PCB. The emission inductance L₁ and the reception inductance L₂ have the same axis Δ. The printed circuit board PCB comprises a through-hole from the top face to the bottom face on the axis Δ of the two inductances. The magnetic coupling element Fe is a rod made of the ferromagnetic material described previously. The rod Fe is inserted into the through-hole, preferably by beginning from the side of the reception inductance L₂. The rod Fe is mechanically secured to the proof body CE. In the absence of deformation of the proof body, the end of the rod preferably stops midway through the thickness of the printed circuit board PCB. The translation of the rod Fe in the through-hole modifies the magnetic coupling between the emission inductance L₁ and the reception inductance L₂. That induces a modification of the frequency and/or of the amplitude of the output signal Vₒᵤₜ as described previously.

FIG. 7 illustrates a cross-sectional view of a fifth embodiment of the inductive part of the sensor D1 according to the invention. The emission inductance L₁ and the reception inductance L₂ are disposed alongside one another. The movable part 2 comprises N (here N=2) magnetic coupling elements Fe₁, Fe₂ mechanically secured to the proof body CE, with N an integer strictly greater than 1. The magnetic coupling elements Fe₁, Fe₂ are aligned in a row. The first magnetic coupling element Fe₁ is coupled with the emission inductance L₁. The second magnetic coupling element Fe₂ is coupled with the reception inductance L₂.

Also, the fixed part 1 comprises N−1 (in the case illustrated, just one) intermediate magnetic coupling elements Fe₁′ disposed between the emission inductance L₁ and the reception inductance L₂. Each intermediate magnetic coupling element Feᵢ′ of rank i is intended to magnetically couple the magnetic coupling element Feᵢ of the same rank i in the row of the movable part 2 to the next magnetic coupling element Feᵢ₊₁. A cascaded magnetic coupling is thus produced.

The magnetic coupling elements Feᵢ of the movable part 2 are separated by a distance d from the magnetic coupling elements Feᵢ′ of the fixed part 1. Said distance is equal to the separation distance between magnetic coupling elements Feᵢ of the movable part 2 and the inductances L₁ and L₂. That makes it possible to increase the dependency of the frequency and/or of the amplitude according to the variation of said separation distance d. More particularly, a d^{N} dependency is obtained which considerably improves the sensitivity of the sensor.

In practice, the high losses in the magnetic coupling elements associated with this configuration cause the influence of the reception inductance L₂ on the resonance frequency or the amplitude to be negligible by comparison to the cumulative effect of the magnetic permeability of the coupling elements as a function of the distance d on the equivalent magnetic permeability of the circuit. It is thus possible to achieve a configuration in which the introduction of a lateral magnetic insulation between the inductances L₁ and L₂ is strong through magnetic shielding. This means that the contribution of the lateral direct magnetic coupling between the inductances L₁ and L₂ is negligible compared to the effect of the magnetic coupling elements Feᵢ and Feᵢ′. The result thereof is that the contribution of the reception inductance L₂ to the variations of the resonance frequency or the amplitude of the output signal Vₒᵤₜ is negligible, above all if the number of turns of the reception inductance L₂ is small, for example 2 to 5 times smaller, than the number of turns of the emission inductance L₁.

Conversely, if the number of turns of the reception inductance L₂ is great compared to that of the emission inductance L₁, for example 2 to 5 times greater, and if the direct lateral magnetic insulation between L₁ and L₂ is great (through shielding), then the contribution of the reception inductance L₂ to the variations of the resonance frequency or to the amplitude of the output signal Vₒᵤₜ can become significant for small variations of d. That induces a significant increase of the range of variation of the frequency and/or of the amplitude of the output signal Vₒᵤₜ

1. An inductive sensor (D1) comprising a fixed part and a movable part, the movable part comprising:
a proof body (CE) that is movable or deformable, in a first direction (Z),
a magnetic coupling element (Fe) mechanically secured to the proof body (CE);
the fixed part comprising:
a voltage generator (G1) configured to generate an excitation signal (Vᵢₙ);
a coil transformer comprising an emission inductance (L₁) mounted in parallel with the generator (G1) and a reception inductance (L₂); the axis of the emission inductance (L₁) and the axis of the reception inductance (L₂) being oriented in the first direction (Z); the magnetic coupling element (Fe) being placed with respect to the coil transformer so as to magnetically couple the emission inductance (L₁) and the reception inductance (L₂); the magnetic coupling element (Fe) being separated from an end of the emission inductance (L₁) by a separation distance (d);
an acquisition chain connected to the reception inductance (L₂) and configured to generate a signal (Vₒᵤₜ) of measurement of the variation of the distance (d) following a movement or the deformation of the proof body (CE); the measurement signal (Vₒᵤₜ) corresponding to a measurement of the variation of the frequency or of the amplitude of the voltage at the terminals of the reception inductance (L₂).

2. The inductive sensor (D1) as claimed in claim 1, wherein the acquisition chain comprises an analogue-digital converter (DAC) for converting the voltage at the terminals of the reception inductance (L₂) into a first digital signal (V_{dig}).

3. The inductive sensor (D1) as claimed in claim 2, wherein the acquisition chain comprises a computer (ECU) configured to:
extract the resonance frequency (f₁) of the voltage at the terminals of the reception inductance (L₂) from the first digital signal (V_{dig}).
calculate the deviation between the extracted resonance frequency (f₁) and a predetermined reference frequency (f₀).

4. The inductive sensor (D1) as claimed in claim 2, wherein the excitation signal (Vᵢₙ) is a square-wave pulse.

5. The inductive sensor (D1) as claimed in claim 2, wherein the fixed part further comprises a capacitive element (C1) and a resistive element (Rs) mounted in series with the emission inductance (L₁) so as to produce an RLC circuit powered by the voltage generator (G1).

6. The inductive sensor (D1) as claimed in claim 2, wherein the acquisition chain comprises a computer (ECU) configured to:
carry out a sampling of the first digital signal (V_{dig}) in order to extract the amplitude (A₁) of the voltage at the terminals of the reception inductance (L₂);
calculate the deviation between the extracted amplitude (A₁) and a predetermined reference amplitude (A₀).

7. The inductive sensor (D1) as claimed in claim 6, wherein the excitation signal (Vᵢₙ) is a voltage ramp.

8. The inductive sensor (D1) as claimed in claim 2, wherein the acquisition chain comprises an amplifier circuit (AMP) mounted upstream of the analogue-digital converter (DAC) to amplify the voltage at the terminals of the reception inductance (L₂).

9. The inductive sensor (D1) as claimed in claim 1, wherein the magnetic coupling element (Fe) is an object made of a ferrite material in π form or in half-torus form or in rod form or in sheet form.

10. The inductive sensor (D1) as claimed in claim 9, wherein the ferrite material is chosen such that the thermal sensitivity of the relative magnetic permeability (μr) of said material is less than 1%/° C.

11. The inductive sensor (D1) as claimed in claim 1, wherein the emission inductance (L₁) and the reception inductance (L₂) are produced by coplanar metal tracks deposited on a printed circuit board (PCB).

12. The inductive sensor (D1) as claimed in claim 1, wherein each of the emission inductance (L₁) and of the reception inductance (L₂) is produced by a coil wound around a solid rod.

13. The inductive sensor (D1) as claimed in claim 1, wherein the emission inductance (L₁) is disposed alongside the reception inductance (L₂) or superposed on the reception inductance (L₂).

14. The inductive sensor (D1) as claimed in claim 1, wherein the movable part comprises N magnetic coupling elements (Fe₁, Fe₂) mechanically secured to the proof body (CE) aligned in a row, with N an integer strictly greater than 1; and wherein the fixed part comprises N−1 intermediate magnetic coupling elements disposed between the emission inductance (L₁) and the reception inductance (L₂).

15. A device for measuring weight or pressure comprising an inductive sensor (D1) as claimed in claim 1.
